(19) United States
(12) Patent Application Publication
(10) Pub. No.: US 2026/0018767 A1
(43) Pub. Date: Jan. 15, 2026

(54) FILLING DEVICE FOR FILLING BATTERY CELLS WITH AN ELECTROLYTE LIQUID

(71) Applicant: Industrie-Partner GmbH Radebeul-Coswig, Coswig (DE)

(72) Inventor: Christian Weiler, Dresden (DE)

(21) Appl. No.: 18/995,528

(22) PCT Filed: Jul. 4, 2023
(86) PCT No.: PCT/EP2023/068347

§ 371 Date: Jan. 16, 2025

(30) Foreign Application Priority Data
Aug. 4, 2022 (DE) 10 2022 119 538.4

(51) Int. Cl. H01M 50/609; G01F 11/06

(52) U.S. Cl. CPC H01M 50/609; G01F 11/06

(57) ABSTRACT

A filling device (1) for filling battery cells with an electrolyte liquid includes a metering cylinder, in which a specified quantity of electrolyte liquid can be received, and a metering piston (10), where the electrolyte liquid quantity received in the metering cylinder can be discharged out of the metering cylinder and transferred into a battery cell. In order to allow a more reliable and precise filling process of the battery cells while minimizing the technical structural complexity, the metering cylinder as well as the metering piston (10) are arranged within a filling device (1) intermediate container (3), which is filled with electrolyte liquid.

### CROSS REFERENCE TO RELATED APPLICATION

The present application is a national stage application of International Patent Application No. PCT/EP 2023/068347 filed on Jul. 4, 2023, which claims the benefit of German Application No. 10 2022 119 538.4, filed on Aug. 4, 2022.

### TECHNICAL FIELD AND BACKGROUND

The invention relates to a filling device for filling battery cells with an electrolyte liquid, having a metering cylinder, in which a specified quantity of the electrolyte liquid can be received, and a metering piston, in which the quantity of the electrolyte liquid received in the metering cylinder can be discharged out of the metering cylinder and transferred into a battery cell.

Battery cells filled with electrolyte liquid are assembled in large number for the purpose of assembling batteries, in particular batteries for the drive system of motor vehicles. Accordingly, these battery cells must be filled with electrolyte fluid with comparatively little technical complexity, wherein the filling procedure is to be configured in the most exact and precise manner possible.

### SUMMARY

Accordingly, the present invention is directed to a filling device for filling battery cells with an electrolyte liquid of the type depicted in the introductory part in such a manner that exact and precisely specifiable filling of the battery cells with electrolyte liquid is made possible without causing a noticeably increased level of technical-constructive complexity for the design of the filling device.

In accordance with one embodiment, the filling device includes a metering cylinder and a metering piston that are arranged within an intermediate container of the filling device which is filled with electrolyte liquid. The resulting direct fluid connection between the intermediate container on the one hand and the metering cylinder on the other hand ensures that the procedure of filling battery cells can be performed precisely and quickly with as little complexity as possible. If, according to one embodiment of the filling device in accordance with the invention, the metering cylinder is arranged in a base part of the intermediate container, the forward and return stroke of the metering piston, which is movable in the metering cylinder, can be implemented in a simple manner, wherein the battery cell to be filled with electrolyte liquid can be arranged in an manner below the base part of the intermediate container.

For the purpose of configuring the drive device for the forward and return stroke of the metering piston as simply as possible, it is advantageous if the piston rod of the metering piston protrudes through a cover of the intermediate container and is sealed by a gap seal or a wiper ring in order to seal the intermediate container. The forward and return stroke movement of the metering piston can then be implemented by a drive arranged externally in relation to the intermediate container whilst keeping the container inner space of the intermediate container sealed.

In another embodiment of the filling device a fluid inlet is arranged between, on the one hand, the intermediate container and, on the other hand, the metering cylinder arranged in the intermediate container, in which fluid inlet a refill valve is seated, such that the fluid inlet between the intermediate container and the metering cylinder can be blocked during a forward stroke of the metering piston and the fluid inlet can be opened during a return stroke of the metering piston. This ensures that the entire electrolyte liquid located within the metering cylinder is transferred into the battery cell during the forward stroke of the metering piston within the metering cylinder, wherein exact filling of the metering cylinder is accomplished once again during the return stroke of the metering piston.

The metering piston and/or the metering cylinder can be formed in an expedient manner from a ceramic or stainless steel material. Depending on the embodiment, the metering piston can have a sealing element or a gap seal.

In order to ensure exact filling of the metering cylinder with the desired filling volume during the return stroke of the metering piston, it is advantageous if a 2-port/2-way valve or a non-return valve is arranged in a fluid connection between the metering cylinder on the one hand and a battery cell, which is to be filled with electrolyte liquid by the filling device, on the other hand, by way of the valve such that the fluid connection can be opened during the forward stroke of the metering piston and can be blocked during the return stroke of the metering piston. Of course, it is possible to connect the intermediate container of the filling device to an electrolyte storage container, wherein for this purpose the intermediate container has, preferably in the region of its cover, a fluid port, by which the intermediate container is connected to the electrolyte storage container.

In order to ensure that unwanted air in the intermediate container can escape from the intermediate container, it is expedient if a ventilation port is formed on the intermediate container and can be used for ventilating the intermediate container. This ventilation port can also be provided in an advantageous manner in the region of the cover of the intermediate container.

In order to ensure that the piston movement is performed precisely during the forward and return stroke of the metering piston, it is advantageous if a receiving and guiding member is provided above the cover of the intermediate container and is used to receive the metering piston on its piston rod protruding through the cover from the intermediate container and can be used to guide said metering piston during the forward and return stroke. Accordingly, the piston rod is attached to this receiving and guiding member at its end portion protruding through the cover, wherein a movement of the receiving and guiding member in an upward and downward direction results correspondingly in a movement of the metering piston within the metering cylinder.

A linear drive has proven to be advantageous as a drive for such a filling device, where the linear drive is accordingly able to drive the metering piston in a desired manner.

If the filling volume of the metering cylinder is dimensioned such that it corresponds to the volume of the battery cell to be filled, a battery cell can be filled in each case with electrolyte liquid by a forward stroke movement of the metering piston in the metering cylinder, and exactly in the intended quantity.

Accordingly, it is also possible to fill a battery cell with the respectively intended amount of electrolyte liquid if the filling volume of the metering cylinder is dimensioned such that the volume of the battery cell to be filled is an integer multiple of the filling volume of the metering cylinder, wherein a corresponding number of forward stroke movements of the metering piston is then required.

Then, end position metering is advantageously provided for the linear drive.

According to an alternative embodiment of the filling device, the filling volume of the metering cylinder is arbitrary, wherein a controllable linear drive is then provided. Accordingly, the metering piston can be brought to a standstill in any position within the metering cylinder as soon as a battery cell is filled with the amount of electrolyte liquid required for the respective battery cell.

In order to enable ventilation of the metering cylinder, it is advantageous if the metering cylinder of the filling device has, in the region of its upper end, a ventilation slot, through which the metering cylinder can be ventilated when a conical tip of the metering piston is arranged in the region of the upper end of the metering cylinder.

A further advantageous embodiment of the filling device in accordance with the invention is achieved if the filling device includes a vacuum chamber which can receive a battery cell which is to be filled with electrolyte liquid in a metered manner by the filling device and is designed as a pouch cell or hard-walled battery cell.

The invention will be explained in greater detail hereinafter with the aid of an embodiment with reference to the drawing, in which:

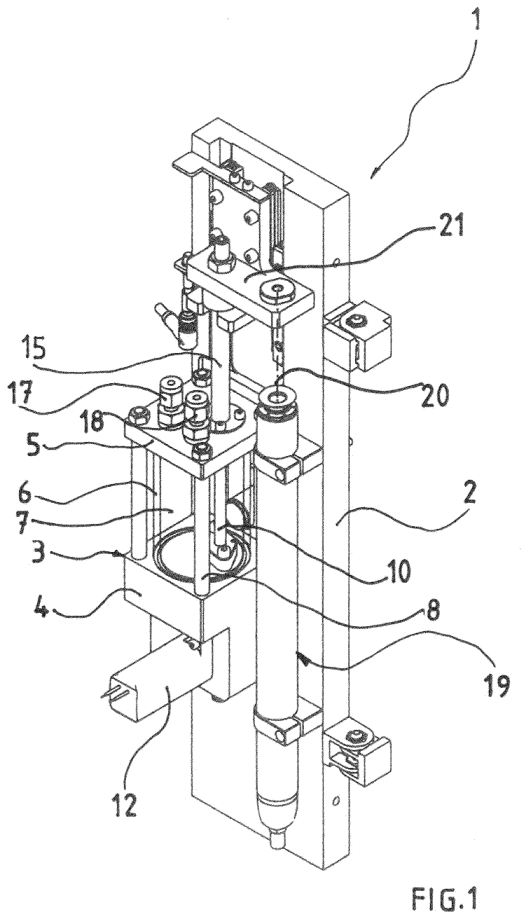

FIG. 1 is a perspective view of an embodiment of a filling device;

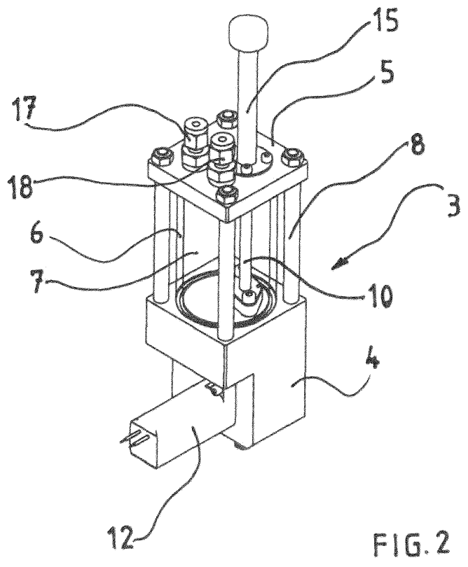

FIG. 2 is a perspective view of an intermediate container of the filling device with its cover and its base part as shown in FIG. 1;

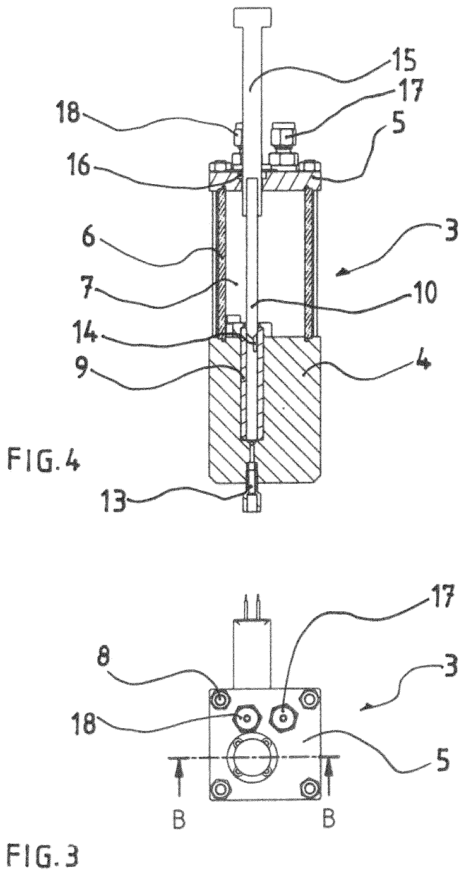

FIG. 3 is s a plan view of the intermediate container shown in FIG. 2;

FIG. 4 is a section view taken along line B-B in FIG. 3;

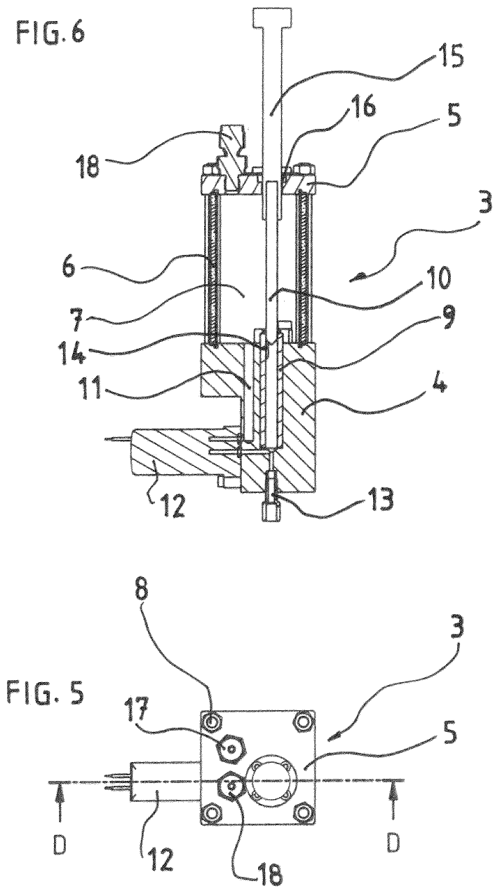

FIG. 5 is a further plan view of the intermediate container shown in FIG. 2; and

FIG. 6 is a section view taken along line D-D in FIG. 5.

An embodiment of a filling device 1 shown in a perspective view in FIG. 1 serves to fill battery cells, not illustrated in the figures, with an electrolyte liquid. It should be possible to fill the battery cells, not illustrated in the figures, in a metered manner in a vacuum, at ambient pressure or overpressure. By means of suitable adapter parts etc., the filling device 1 in accordance with the invention which is depicted in greater detail hereinafter can be used to fill battery cells of different designs. The filling device 1 can also include a vacuum chamber in which a battery cell which is to be filled by means of the filling device 1 and is designed as a pouch cell or hard-walled battery cell can be received.

The embodiment of the filling device 1 shown in FIG. 1 includes a frame part 2, by the filling device 1 is supported. The individual components of the filling device 1 which are described hereinafter are mounted on the frame part 2.

As is apparent from a combined view of FIGS. 1 and 2, the filling device 1 includes an intermediate container 3 that is fastened to the frame part 2 of the filling device 1. The intermediate container 3 has a base part 4, a cover 5, and a glass wall 6, which is cylindrical in the illustrated embodiment of the intermediate container 3 and which together with the base part 4 and the cover 5 forms a container inner space 7 of the intermediate container 3. The base part 4 is fixedly connected to the cover 5 of the intermediate container 3 by a screw connections 8, wherein the screw connections 8 are arranged at the corners of the base part 4 and the cover 5. Furthermore, the filling device 1 in accordance with the invention shown in FIG. 1 includes a metering cylinder 9. A quantity of the electrolyte liquid that can be specified by the freely configurable volume of the metering cylinder 9 can be received in the metering cylinder 9. The metering cylinder 9 is arranged substantially within the base part 4 of the intermediate container 3. A metering piston 10 of the filling device 1 can be moved within the metering cylinder 9 in the up and down direction shown in FIGS. 1, 2, 4 and 6. In its upper position shown in FIGS. 4 and 6, the metering piston 10 has just performed a return stroke movement. During this return stroke movement, in which the metering piston 10 has moved from its lower position, not shown in the figures, to the upper position shown in FIGS. 4 and 6, the metering cylinder 9 is filled with electrolyte liquid from the container inner space 7 of the intermediate container 3 which is filled with electrolyte liquid. For this purpose, as is apparent from FIG. 6, a fluid inlet 11 is formed in the base part 4 of the intermediate container 3 and is connected to the lower end portion of the metering cylinder 9 via a refill valve 12. During the return stroke of the metering piston to its upper position shown in FIGS. 4 and 6, the refill valve 12 opens the connection between the fluid inlet 11 and the lower end region of the metering cylinder.

During a forward stroke movement of the metering piston 10, which is directed in a downward direction shown in FIGS. 1, 2, 4 and 6, the refill valve 12 blocks the connection between the fluid inlet 11 and the lower end portion of the metering cylinder 9. Accordingly, the electrolyte liquid located in the metering cylinder 9 is transported by the metering piston 10 through a fluid connection 13 formed at the lower end portion of the metering cylinder 9 into the inner space of the battery cell, not shown in the figures, which is connected to the filling device 1. A 2-port/2-way valve or a non-return valve is arranged in the fluid connection 13. During the forward stroke movement of the metering piston 10, the fluid connection 13 to the battery cell is opened, whereas this fluid connection 13 is blocked during the return stroke of the metering piston 10.

A ventilation slot, through which the metering cylinder 9 can be ventilated, is formed on the upper end portion of the metering cylinder 9.

The drive movement for the forward stroke and return stroke of the metering piston 10 is transmitted thereto by means of a piston rod 15, to which the metering piston 10 is fastened and which protrudes from the intermediate container 3 through the cover 5 thereof. A suitable gap seal 16 is provided for sealing between the outer surface of the piston rod 15, which is movable in relation to the cover 5 of the intermediate container 3, and the cover 5. A wiper ring or similar seal can also be provided instead of the gap seal 16.

In the illustrated exemplified embodiment, the metering piston 10 is cylindrical, wherein its external dimensions correspond to the internal dimensions of the metering cylinder 9. At its lower end portion facing the lower end portion of the metering cylinder 9, the metering piston 10 has a conical tip. By reason of the configuration of the lower end of the metering piston 10 as a conical tip, the ventilation slot 14 formed in the metering cylinder 9 at its upper end portion is opened comparatively early during the return stroke movement of the metering piston 10.

In the illustrated exemplified embodiment, the intermediate container 3 has, on its cover 5, a fluid port 17, through which the intermediate container 3 of the filling device 1 can be filled with electrolyte liquid from an electrolyte storage container, not shown in the figures. In addition, a ventilation port 18, through which the container inner space 7 of the intermediate container 3 can be ventilated, is provided on the cover 5 of the intermediate container 3.

In order to perform the forward and return stroke movement of the metering piston 10, a linear drive 19 is arranged on the frame part 2 of the filling device 1. The linear drive 19 is connected to a receiving and guiding member 21 via a drive member 20 which, in graphical terms, is only indicated in FIG. 1. By way of the linear drive 19, the receiving and guiding member 21, to which the upper end of the piston rod 15 protruding upwards through the cover 5 of the intermediate container 3 is fastened, and thus the piston rod 15 and the metering piston 10 can be moved in the upward and downward direction shown in the figures. In order to ensure an exact mechanical connection between the linear drive 19 on the one hand and the piston rod 15 on the other hand, the receiving and guiding member 21 is movably guided and supported on the frame part 2 in a suitable manner.

The linear drive 19 can be configured with end position metering, wherein the filling volume of the metering cylinder 9 can then correspond to the volume of the battery cell to be filled or the volume of the battery cell to be filled can be an integer multiple of the filling volume of the metering cylinder 9.

The linear drive 19 can also be designed as a linear drive which can be controlled arbitrarily. The filling volume of the metering cylinder 9 can then be designed arbitrarily without encountering any adverse effects during filling of battery cells.

1. A filling device for filling battery cells with an electrolyte liquid, said filling device comprising:
a metering cylinder in which a specified quantity of the electrolyte liquid can be received;
a metering piston for receiving the quantity of electrolyte liquid received in the metering cylinder can be discharged out of the metering cylinder and transferred into a battery cell, characterised in that both the metering cylinder and the metering piston are arranged within an intermediate container of the filling device filled with electrolyte liquid.

2. The filling device as claimed in claim 1, wherein the metering cylinder is arranged in a base part of the intermediate container.

3. The filling device as claimed in claim 1- or 2, wherein the metering piston includes a piston rod, the piston rod protruding through a cover of the intermediate container and being sealed with respect to the cover of the intermediate container by a gap seal or a wiper ring.

4. The filling device as claimed in claim 1, wherein a fluid inlet is arranged between, on the one hand, the intermediate container and, on the other hand, the metering cylinder arranged in the intermediate container, in which fluid inlet a refill valve is seated, by the fluid inlet between the intermediate container and the metering cylinder can be blocked during a forward stroke of the metering piston and the fluid inlet can be opened during a return stroke of the metering piston.

5. The filling device as claimed claim 1, wherein the metering piston and/or the metering cylinder is/are formed from a ceramic or stainless steel material.

6. The filling device as claimed in claim 5, wherein the metering piston is formed from a stainless steel material and has a sealing element.

7. The filling device as claimed in claim 5, wherein the metering piston is formed from a ceramic material and is sealed by means of a gap seal.

8. The filling device as claimed in claim 1, wherein a 2-port/2-way valve or a non-return valve is arranged in a fluid connection between the metering cylinder on the one hand and a battery cell, which is to be filled with electrolyte liquid by means of the filling device, on the other hand, by means of which valve the fluid connection can be opened during the forward stroke of the metering piston and can be blocked during the return stroke of the metering piston.

9. The filling device as claimed in claim 1, which includes a fluid port, by which the intermediate container of the filling device can be connected to an electrolyte storage container.

10. The filling device as claimed in claim 1, wherein a ventilation port, by which the intermediate container can be ventilated, is formed on the intermediate container.

11. The filling device as claimed in claim 1, which has, above the cover of the intermediate container, a receiving and guiding member which can be used to receive the metering piston on its piston rod protruding through the cover from the intermediate container and to guide said metering piston during the forward and return stroke.

12. The filling device as claimed in claim 1, which has a linear drive, by means of which the metering piston can be driven.

13. The filling device as claimed in claim 1, wherein the filling volume of the metering cylinder is dimensioned such that it corresponds to the volume of the battery cell to be filled.

14. The filling device as claimed in claim 13, wherein the filling volume of the metering cylinder is dimensioned such that the volume of the battery cell to be filled is an integer multiple of the filling volume.

15. The filling device as claimed in claim 13, wherein a linear drive having end position metering is provided.

16. The filling device as claimed in claim 1, wherein the filling volume of the metering cylinder is arbitrary and a controllable linear drive is provided.

17. The filling device as claimed in claim 1, of which the metering cylinder has, in the region of its upper end, a ventilation slot, through which the metering cylinder can be ventilated if when a conical tip of the metering piston is arranged in the region of the upper end of the metering cylinder.

18. The filling device as claimed in claim 1, having a vacuum chamber which can receive a battery cell which is to be filled with electrolyte liquid in a metered manner by means of the filling device and is designed as a pouch cell or hard-walled battery cell.

19. The filling device as claimed in claim 11, which has a linear drive to drive the metering piston.

20. The filling device as claimed in claim 19, wherein the filling volume of the metering cylinder is dimensioned such that it corresponds to the volume of the battery cell to be filled.
